(19) United States
(12) Patent Application Publication
(10) Pub. No.: US 2008/0284205 A1
(43) Pub. Date: Nov. 20, 2008

(54) STRUCTURAL COMPONENT

(75) Inventor: Trevor J. Rossi, Lasalle (CA)

Correspondence Address: GIFFORD, KRASS, SPRINKLE,ANDERSON & CITKOWSKI, P.C, PO BOX 7021, TROY, MI, 48007-7021, US

(73) Assignee: Z F GROUP NORTH AMERICAN OPERATIONS, INC., Northville, MI (US)

(21) Appl. No.: 12/121,256

(22) Filed: May 15, 2008

Related U.S. Application Data
(60) Provisional application No. 60/938,293, filed on May 16, 2007.

(51) Int. Cl. B60G 25/00; B21D 47/00

(52) U.S. Cl. 296/187.01; 29/897.3

(57) ABSTRACT

A lightweight motor vehicle structural component is provided. The component has at least one fully-boxed section extending in a longitudinal direction, the fully-boxed section made from a single piece of sheet metal. In addition, the fully-boxed section has a generally U-shaped first portion which has an open side that is oppositely disposed from and in alignment with a second portion.

### CROSS-REFERENCE TO RELATED APPLICATIONS

This application claims priority of U.S. Provisional Patent Application Ser. No. 60/938,293 filed May 16, 2007, which is incorporated herein by reference.

### FIELD OF THE INVENTION

This invention relates generally to a structural component. More specifically, the invention relates to a structural component made from a single piece of sheet metal and having a fully-boxed cross section.

### BACKGROUND OF THE INVENTION

Various fabrication methods can be used to produce structural components. For example, motor vehicle chassis components can be made from castings, stamped sheet metal, machine components and the like. In particular, motor vehicle chassis components can be manufactured from stamped sheet metal. A stabilizer component formed by stamping a piece of sheet metal is shown generally at reference numeral 5 in FIG. 1. As shown in this figure, the component includes channels, ridges and the like to provide desired mechanical properties such as stiffness and strength. However, the component shown in FIG. 1 must be made from relatively thick sheet metal in order to provide the desired mechanical properties. If a method, process, design and/or component could be provided that would permit a thinner material to be used, cost savings could be obtained. Therefore, there is a need for an improved structural component and a method for making the component.

### SUMMARY OF THE INVENTION

A lightweight structural component is provided. The component has at least one fully-boxed section extending in a longitudinal direction, the fully-boxed section made from a single piece of sheet metal. In addition, the fully-boxed section has a generally U-shaped first portion which has an open side that is oppositely disposed from and in alignment with a second portion. The component also has an attachment section that is integral with the at least one fully-boxed section, the attachment section providing for the attachment of the component to a separate structure. A width of the U-shaped first portion is generally equal to a width of the second portion. The second portion is an elongated section that is adjacent to and oppositely disposed from the open side of the U-shaped first portion. In some instances, the second portion is a second U-shaped portion with an open side that is adjacent to and oppositely disposed from the open side of the U-shaped first portion. The U-shaped second portion that is in alignment and oppositely disposed from the U-shaped first portion can form a butt joint, lip joint, lap joint and the like therebetween.

The at least one fully-boxed section can be two separate fully-boxed sections, the two separate fully-boxed sections being spaced apart from each other and joined together by an elongated section of the single piece of sheet metal. In some instances, two elongated sections can join the two separate fully-boxed sections together and may or may not form yet another fully-boxed section. The attachment section can have an aperture therethrough in order to provide and assist in the attachment of the component to the separate structure.

A process for making the lightweight structural component includes providing a single piece of sheet metal that has at least one wide-section and at least one thin-section extending therefrom. The wide-section has at least two break lines thereon that are spaced a distance apart from each other and extend along a longitudinal direction of the piece of sheet metal. The thin-section has at least two break lines spaced apart from each other that extend along a transverse direction. After the piece of sheet metal has been provided, it is broken along the at least two wide-section break lines to form the generally U-shaped first portion with an open side. In addition, the piece of sheet metal is broken along the at least two break lines on the thin-section such that the second portion is adjacent to and oppositely disposed from the open side of the U-shaped first portion. A seam is present between the U-shaped first portion and the second portion, the seam being at least partially sealed in order to form a fully-boxed section.

### BRIEF DESCRIPTION OF THE DRAWINGS

FIG. 1 is a perspective view of a prior art structural component;

FIG. 2 is a perspective view of an embodiment of the present invention;

FIG. 3 is a cross-sectional view of section 3-3 shown in FIG. 2;

FIG. 4 is a top view of a piece of sheet metal used to form the embodiment shown in FIG. 2;

FIG. 5 is a side cross-sectional view of another embodiment;

FIG. 6 is a top view of a piece of sheet metal used to form the component shown in FIG. 5;

FIG. 7 is a perspective view of another embodiment of the present invention;

FIG. 8 is a top view of a piece of sheet metal used to form the embodiment shown in FIG. 7;

FIG. 9 is a top view of a piece of sheet metal used to form an embodiment of the present invention shown in FIG. 10; and

FIG. 10 is a perspective view of the embodiment of the present invention made from the piece of sheet metal shown in FIG. 9.

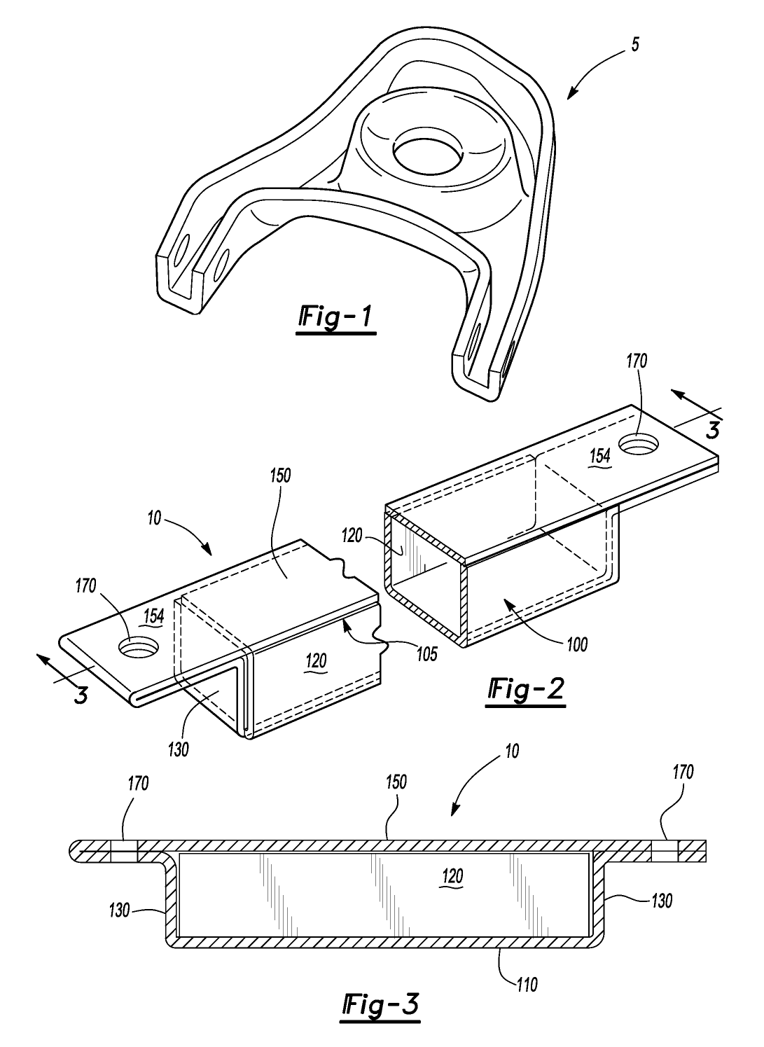

### DETAILED DESCRIPTION OF THE INVENTION

The present invention discloses a structural component made from a single piece of sheet metal and having a fully-boxed section. The structural component is lightweight compared to heretofore components made for the same purpose while maintaining desired mechanical properties such as stiffness and strength, and therefore has utility as a lightweight and cost efficient structural component.

The structural component is made from a single piece of sheet metal and has at least one fully-boxed section extending in a longitudinal direction. For the purposes of the present invention, the term “fully-boxed section” is defined as a section having a cross-section in the form of a closed polygon. In some instances, the fully-boxed section includes a generally U-shaped (hereafter simply referred to as U-shaped) first portion with an open side that is oppositely disposed from and in alignment with a second portion. In addition, the fully-boxed section has an attachment section that is integral therewith.

The U-shaped first portion of the component has a width that is generally equal to a width of the second portion. The second portion can be an elongated section that is adjacent to and oppositely disposed from the open side of the U-shaped portion. In some instances, the second portion is also an U-shaped portion with an open side that is adjacent to and oppositely disposed from the open side of the U-shaped first portion. A seam is present between the U-shaped first portion and the second portion and can be in the form of a butt joint, lip joint, lap joint and the like.

The at least one fully-boxed section can include two separate fully-boxed sections, the two fully-boxed sections being spaced apart from each other and joined together by two elongated section of the single piece of sheet metal. In some instances, two elongated sections can join the two separate fully-boxed sections together and may or may not form yet another fully-boxed section.

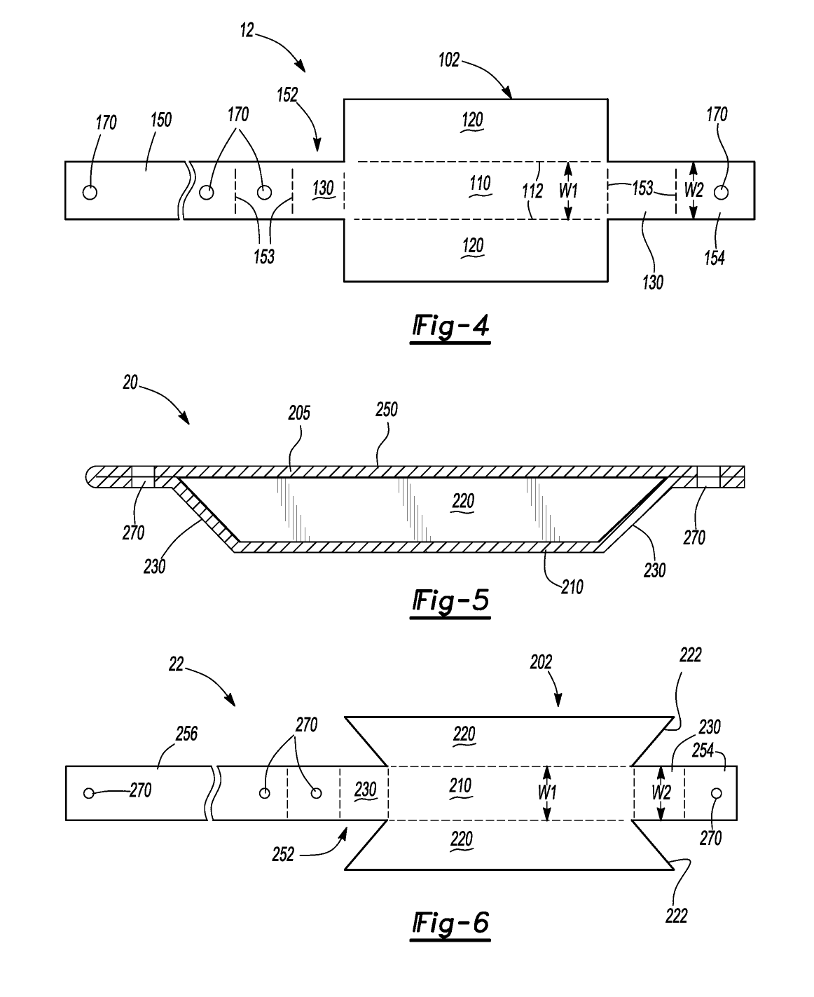

Turning now to FIGS. 2-4, an embodiment of a structural component is shown generally at reference numeral 10. The component 10 is made from a single piece of sheet metal 12 and has a U-shaped first portion 100 and a second portion 150. The U-shaped first portion 100 is made from a wide-section 102 of the piece of sheet metal 12, the wide-section 102 having a central section 110 and two side sections 120. Between the central section 110 and the side sections 120 is at least one break line 112 as shown in FIG. 4. Extending from the wide-section 102 is at least one thin-section 152. The thin-section 152 has at least two break lines 153 that extend in a transverse direction across the thin-section. In some instances, the piece of sheet metal 12, and thus the structural component 10, have an aperture 170 that assists in the attachment of the structural component 10 to a separate component, for example a motor vehicle chassis. The central section 110 has a width W1 that is generally equal to a width W2 of the thin-section 152. It is appreciated that upon breaking of the wide-section 102 along the break lines 112, a generally U-shaped cross section is formed and provides for the U-shaped first portion 100 with an open side. Likewise, breaking of the break lines 153 provides for end sections 130 that bound the U-shaped first portion 100, attachment sections 154 and/or the second portion 150.

Between the U-shaped first portion 100 and the second portion 150 is a seam 105. A seam can also be present between the side sections 120 and the end sections 130 as shown in FIG. 2. It is appreciated that the seam 105 can be in the form of a butt joint, a lip joint, a lap joint and the like. In addition, the seam 105 can be sealed using welding, fasteners, adhesives and the like. Thus as shown in FIG. 2, a structural component 10 is provided that has a fully-boxed section with an attachment section extending therefrom, the component 10 affording desired mechanical properties while using thinner sheet metal than a similar component not having the same structure.

Turning now to FIGS. 5 and 6, another embodiment of a structural component is shown generally at reference numeral 20, the component 20 being made from a single piece of sheet metal 22. The structural component is similar to the structural component 10 shown in FIG. 2 except for end sections 230 that extend at an angle from central section 210 towards second portion 250. It is appreciated that the angled sections 222 of the side sections 220 allow the end sections 230 to slant towards the second portion 250 and yet maintain a seam therebetween. In this manner a fully-boxed section having different shapes allowing for clearance of other components when attached to a separate structure can be provided. Also similar to the piece of sheet metal 12 in FIG. 4, the central section 210 has a width WI that is generally equal to a width W2 of a thin-section 252 extending therefrom.

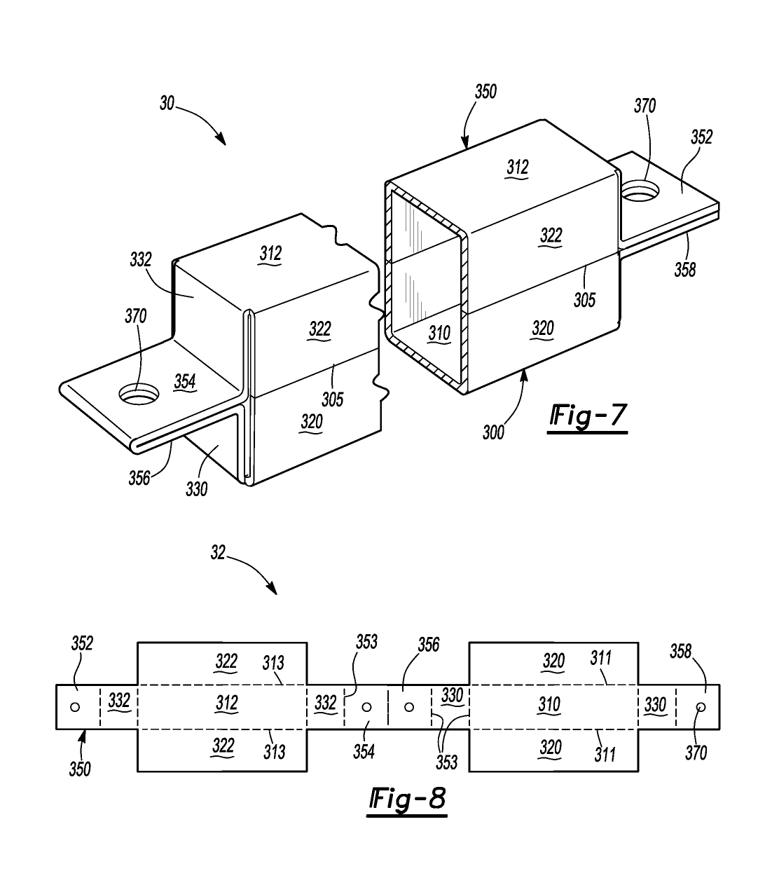

Turning now to FIGS. 7 and 8, another embodiment of a structural component 30 made from a single piece of sheet metal 32 is shown. In this embodiment, the structural component 30 has a U-shaped first portion 300 with an open side and the second portion 350 also being a U-shaped portion with an open side. Similar to the previous embodiments, a seam 305 is present between the U-shaped first portion 300 and the second portion 350.

The piece of sheet metal 32 similarly has a central section 310 with side sections 320 that afford for the U-shaped first portion 300 to be formed by breaking along the break lines 311. Similarly, the second portion 350 is made by breaking along the break lines 313 that are between the central section 312 and the side sections 322. Breaking along the transverse break lines 353 affords for the second portion 350 to be folded over the U-shaped first portion 300 as shown in FIG. 7 such that the open side of the second portion 350 is adjacent to and oppositely disposed from the open side of the U-shaped first portion 300.

A seam 305 is present between the U-shaped first portion 300 and the second portion 350 and can be in the form of a butt joint, lip joint, lap joint and the like. As such, the seam 305 can be sealed using welding, adhesives, fasteners and the like and thereby provide for a fully-boxed section. Similar to the previous embodiments, an aperture 370 can be provided which aids in the attachment of the structural component 30 to a separate structure.

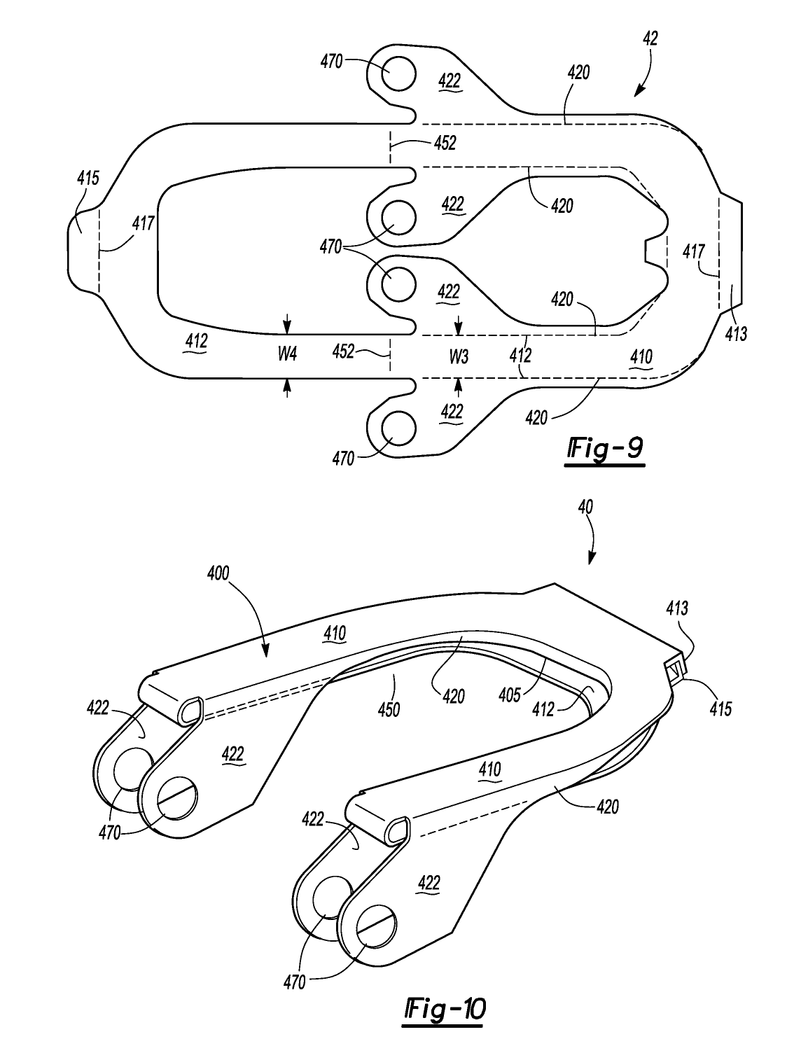

Turning now to FIGS. 9 and 10, another embodiment of a structural component 40 made from a single piece of sheet metal 42 is shown. In this embodiment, the piece of sheet metal 42 has a generally oval shape with a thin-section 412 and an attachment section 422 extending from a wide-section 410. Breaking along break lines 412 within the wide-section 410 provides a generally U-shaped first portion 400. Likewise, breaking along break lines 452 affords for the U-shaped first portion 400 to be folded over the second portion 450, the second portion 450 optionally being in the form of a U-shape. A seam 405 is present between the U-shaped first portion 400 and the second portion 450 and can be at least partially sealed using welding, adhesives, fasteners and the like.

The break lines 412 have a width W3 that is generally equal to a width W4 of the second portion 450, or in the alternative, the width W3 can be generally equal to a width of a central section of the second portion 450 when the second portion 450 has a U-shaped form. Optionally included can be tabs 413 and 415 which can be broken along break lines 417 in order to form overlapping tabs as shown in FIG. 10. It is appreciated that the attachment section 422 with the apertures 470 afford the component 40 to be attached to a separate structure, for example a motor vehicle chassis, frame and the like. Thus similar to the previous embodiments, a structural component having a fully-boxed section is provided.

A process for making a lightweight structural component can include providing a single piece of sheet metal having at least one wide-section and at least one thin-section extending therefrom. The piece of sheet metal has at least two break lines on the wide-section that are spaced a distance apart from each other and extend along a longitudinal direction. The thin-section has at least two break lines that extend along a transverse direction. After the piece of sheet metal with the break lines has been provided, it is broken along the break lines of the wide-section in order to form an U-shaped first portion with an open side. In addition, the break lines that extend across the thin-section in a transverse direction are broken and afford for a second portion to be adjacent to and oppositely disposed from the open side of the U-shaped first portion. The break lines can be broken using any device, method and the like known to those skilled in the art, illustratively including a sheet metal breaker, a stamping machine, a hammer and the like. A seam is present between the second portion and the U-shaped first portion, the seam being sealed and therefore affording a fully-boxed section. In addition, the single piece of sheet metal can be made from any material known to those skilled in the art for making structural components, illustratively including a ferrous alloy, an aluminum alloy, a nickel alloy, a titanium alloy, a cobalt alloy, a copper alloy and the like. The seam can be in the form of a butt joint, lip joint, lap joint and the like and can be sealed using welding, adhesives, fasteners and the like.

The foregoing drawings, discussion and description are illustrative of specific embodiments of the present invention but they are not meant to be limitations upon the practice thereof. Numerous modifications and variations of the invention will be readily apparent to those of skill in the art in view of the teaching presented herein. It is the following claims, including all equivalents, which define the scope of the invention.

We claim:

1. A lightweight structural component made from a single piece of sheet metal, the component comprising:
at least one fully-boxed section extending in a longitudinal direction, said fully-boxed section made from the single piece of sheet metal and having a generally U-shaped first portion, said generally U-shaped first portion having an open side oppositely disposed from and in alignment with a second portion; and
an attachment section integral with said at least one fully-boxed section for attaching the component to a separate structure.

2. The lightweight structural component of claim 1, wherein a width of said generally U-shaped first portion is generally equal to a width of said second portion.

3. The lightweight structural component of claim 1, wherein said second portion is an elongated section of the single piece of sheet metal adjacent to and oppositely disposed from said open side of said generally U-shaped first portion.

4. The lightweight structural component of claim 1, wherein said second portion is a generally U-shaped second portion adjacent to and oppositely disposed from said open side of said generally U-shaped first portion.

5. The lightweight structural component of claim 4, wherein said single piece of sheet metal is made from an alloy selected from the group consisting of a ferrous alloy and an aluminum alloy.

6. The lightweight structural component of claim 1, wherein said generally U-shaped first portion in alignment with said second portion has a seam therebetween.

7. The lightweight structural component of claim 1, wherein said at least one fully-boxed section is two separate fully-boxed sections, said two fully-boxed sections spaced apart from each other and joined together by two elongated sections of said single piece of sheet metal.

8. The lightweight structural component of claim 7, wherein said two elongated sections of said single piece of sheet metal that join said two separate fully-boxed sections is a fully-boxed section.

9. The lightweight structural component of claim 1, wherein said attachment section has an aperture therethrough.

10. The lightweight structural component of claim 1, wherein the component is a motor vehicle suspension component.

11. A process for making a lightweight structural component, the process comprising:
providing a piece of sheet metal having at least one wide-section and at least one thin-section extending therefrom, the piece of sheet metal having at least two break lines on the wide-section that are spaced a distance apart from each other and extend along a longitudinal direction, the piece of sheet metal also having at least two break lines on the thin-section that extend along a transverse direction;
breaking the at least one wide-section along the at least two wide-section break lines to form a generally U-shaped first portion with an open side;
breaking the at least one thin-section along the at least two thin-section break lines to form an attachment section and a second portion that is adjacent to and oppositely disposed from the open side of the generally U-shaped first portion; and
sealing at least part of a seam that is between the generally U-shaped first portion and the second portion in order to form a fully-boxed section with the attachment section integral with and extending therefrom.

12. The process for making a lightweight structural component of claim 11, wherein a width of the distance between the at least two break lines on the wide-section is generally equal to a width of the thin-section.

13. The process for making a lightweight structural component of claim 11, wherein the single piece of sheet metal is made from a ferrous alloy.

14. The process for making a lightweight structural component of claim 11, wherein the generally U-shaped first portion and the second portion have a longitudinal seam therebetween.

15. The process for making a lightweight structural component of claim 11, wherein the at least one fully-boxed section is two separate fully-boxed sections spaced apart from each other.

16. A process for making a lightweight motor vehicle component, the process comprising:
providing a single piece of sheet metal having a generally oval-shape, the oval-shaped piece of sheet metal having at least one wide-section and at least one thin-section extending therefrom,
forming at least two break lines that are spaced a distance apart from each other and extend along a longitudinal direction on the wide-section;
forming at least two break lines that are spaced a distance apart from each other and extend along a transverse direction on the thin-section;
breaking the at least one wide-section along the at least two wide-section break lines to form a generally U-shaped first portion with an open side;
breaking the at least one thin-section along the at least two thin-section break lines to form an attachment section and a second portion that is adjacent to and oppositely disposed from the open side of the generally U-shaped first portion; and
sealing at least part of a seam that is between the generally U-shaped first portion and the second portion in order to form at least one fully-boxed section with the attachment section integral with and extending therefrom.

17. The process for making a lightweight motor vehicle component of claim 16, wherein the single piece of sheet metal is made from a ferrous alloy.

18. The process for making a lightweight motor vehicle component of claim 16, wherein a width of the distance between the at least two break lines on the wide-section is generally equal to a width of the thin-section.

19. The process for making a lightweight motor vehicle component of claim 16, wherein the at least one fully-boxed section is two separate fully-boxed sections spaced apart from each other.

20. The process for making a lightweight motor vehicle component of claim 19, wherein the attachment section is two attachment sections, each attachment section being made from a pair of attachment tabs extending from each of the fully-boxed sections.
